(19) United States
(12) Patent Application Publication
(10) Pub. No.: US 2002/0087665 A1
(43) Pub. Date: Jul. 4, 2002

(54) Method and system for integrated resource management

(76) Inventors: Donald Brent Marshall, Ottawa (CA); Bryn P. Rahm, Kanata (CA); Michael A. Leeder, Stittsville (CA)

Correspondence Address: Hunton & Williams, 1900 K Street, N.W., Washsington, DC, 20006-1109, US

(21) Appl. No.: 09/750,303

(22) Filed: Dec. 29, 2000

(51) Int. Cl. G06F 15/177; G06F 17/30

(52) U.S. Cl. 709/220; 707/10

(57) ABSTRACT

The present invention relates to a method and system for enabling resources to be defined, tracked, verified, resolved and managed both statically and dynamically. Resource management may be performed explicitly and consistently throughout a system, regardless of resource type. When a resource is defined, the resource may be assigned a unique specifier which may include a resource ID, type ID, version ID and/or other identifier. This information may be stored in a centralized repository, preventing redundant definitions of similar resources. Software or other applications may request (or require) access to a resource from a resource manager, regardless of resource type, retrieval mechanism or location.

### FIELD OF INVENTION

The present invention relates to a method and system for enabling resources to be defined, tracked, verified, resolved and managed statically and dynamically wherein resource management is performed explicitly and consistently throughout the system regardless of resource type.

### BACKGROUND OF THE INVENTION

Software applications generally have requirements on certain resources in their target environment. For example, an application may depend upon the availability of data files, databases, network servers, certain software processes (local or remote), etc. Typically, applications themselves may be required to retrieve these resources directly when they are executed.

This requires that applications must be aware of the details of the environment into which they will be deployed. The applications must access different facilities to retrieve each of the resources which it requires. This requires the application to know the details of how a resource is provided, making it difficult to provide the resource in a different, but functionally equivalent way. A resource, for example, may include anything which may be needed for a service to execute successfully, such as a database, network addresses, switches, hardware, software, control logic and other components.

Furthermore, applications may be coupled to specific implementation or configuration details of the resources they require, such as specific implementation classes, or specific network addresses. This greatly decreases the flexibility and variety of environments into which the application may be deployed.

In networks, there may often exist incompatibilities among various components and other hardware. For example, in a wide area network, different servers, databases or communication links may have different requirements which, if substituted, may interrupt communications.

As another example, in a cell phone network, different cell phone equipment may have varying requirements for proper and efficient communication. Generally, a cell phone (or other communication device) may transmit to a mobile switching office which may be used to translate phone numbers (or other identifiers) to connect the transmitting party to the desired one or more recipients. The mobile switching office may receive cell phone (or other) transmissions to route the transmissions to the network or resource (e.g., database). Generally, a server may be configured to format to a specific database (or other resource). Each component of a network is dependent on each other for compatibility and proper communication.

If a database (or other resource) is to be removed (or otherwise modified), reconfiguration of the server and other components may be required. This may entail downing the system, making the necessary modifications, loading software, rebooting, and performing other additional operations. Thus, if a phone server (or other types of resources) are modified (e.g., upgraded, etc.), changes in hardware and other components in a mobile switching office or other network elements may be necessary.

Currently, modifications (including upgrades) in a network (such as a cell phone network) are difficult and time consuming due to the dependency on components within the network.

Further, within a network, resources generally involve databases, network addresses, software to be retrieved, and other hardware and software used to support connections. Due to the dependency on components for compatibility, resources have been traditionally hardwired to various components within a network. Essentially, every device in a chain had to know the identify and type of devices in the rest of the chain to obtain the requested information.

Generally, a specific address with a specific address number associated with components in a network have been used to obtain the requested information. Therefore, modifications and upgrades have been difficult and tedious when resources are dependent on hardware components within a network. Generally, system crashes and other impediments occur when modifying resources, such as upgrades in databases.

Moreover, systems generally use separate identification schemes depending on the type of resource and other characteristics of a resource. However, this approach prevents or inhibits a comprehensive approach to management of the resource ID space. When more than one geographically dispersed groups of people (or other entities) define resources, conflicts in the ID space frequently result. These conflicts are often not discovered until the conflicts cause problems in the field.

Currently, Common Object Request Broker Architecture (“CORBA”) and Jini support the discovery of resources independent of the resource's location. However, once associations are established between resources, those platforms do not tie in the management system to maintain the state of these associations, and have it reflected in the status of the dependent resources. The mechanisms used by CORBA and Jini are only applicable to a specific type of resource (e.g., software processes). Where appropriate (e.g., for external software processes) the Jini and CORBA mechanisms may be the underlying retrieval mechanism used by a Resource Manager. Other mechanisms may be used for other types of resources.

Traditionally, resource management has been complicated in the past due to the use of a variety of different resource management schemes in different contexts and for different resource types. The traditional method of resource management has made it more difficult to create a consistent set of rules for resource management. For example, designers, installers, support entities may be required to learn and implement a variety of rules which apply in different special cases. Also, the power of the resource management toolset may be reduced where enhancements may be replicated across a variety of tools.

These and other drawbacks exist with current systems.

### Summary of the Invention

An object according to the present invention is to overcome these and other drawbacks with existing network systems.

The present invention in one regard relates to a method and system for enabling resources to be defined, tracked, verified, resolved and managed both statically and dynamically. Resource management may be performed explicitly and consistently throughout a system, regardless of resource type. When a resource is defined, the resource may be assigned a unique specifier which may include a resource ID, type ID, version ID and/or other identifier. This information may be stored in a centralized repository, preventing redundant definitions of similar resources, or conflicting use of the same resource ID. Software or other applications may request (or require) access to a resource from a resource manager, regardless of resource type, retrieval mechanism or location. The resource manager may return a reference to the requested resource or a proxy for the requested resource.

The resource management strategy of the present invention advocates a single, consistent approach to be used system-wide, regardless of resource type.

Another embodiment of the invention involves enabling software to connect to requested (or required) resources regardless of location by resolving an abstract resource ID, type ID, and version ID. Other identifiers may also be used. When several interchangeable instances of a particular resource are available, the number of instances, and the algorithm for selecting among them when they are requested may be transparent to the requesting entity. The type of algorithm may vary by resource type, without the necessary knowledge of either the requesting entity of the requested resource. When appropriate, the algorithm for selecting among the instances may take into account the management state (e.g., availability, business, etc.) of the different instances. For example, this may be used to transparently provide load balancing, fault-tolerant redundancy, etc.

The present invention allows transparent upgrades of resources to new versions, without the entities which use them becoming aware of the upgrade. The invention further allows the resources to be defined in parallel by many independent groups of people or entities, without risking conflicting resource identifiers. The present invention further facilities and accommodates changes over time in the resource identifiers. The present invention may also allow multiple resource IDs to be logically mapped to the same entity. Thus, resource ID schemes may reflect attributes of the resource which may change over time. For example, a resource may be identified as “customerX.featureY” when it is initially created, but later be renamed to “shared.featureY”. Users who continue to request customerX.featureY may transparently receive shared.featurey, for example.

The centralized management of resource identifiers may allow many service developers who may be physically and organizationally remote from each other to define and create new resources without the risk of clashes and other inconsistencies. For example, clashes and inconsistencies may otherwise prevent or impede the deployment of resources from more than one source, because the co-existence of resources with identical identifiers in the same network may not be permissible. The dynamic binding of resources independent of their physical location in the network may allow services to be deployed to a variety of different network topologies.

This enables services developed by third parties to be deployed to a number of service provider networks, which may be useful in enabling third party service creation business models. Similar benefits, which may enable third party service development, may also reduce the effort a service provider may be required to invest in customizing services for individual service providers and their networks. Thus, development resources or other entities may not be required to create new services.

In particular, without a system to centrally manage resource identifiers created by different service providers, third parties, and other entities, a service provider may be required to invest large amounts of effort and finances to manually manage resource identifiers. The dynamic binding of resources via resource ID, version ID and other identifiers may enable resources to be upgraded in the network without effecting the entities which use the resources. This dynamic binding, combined with the resource resolution mechanism, may allow new instances of a particular type of resource to be dynamically added to a network, without requiring modifications or re-configuration in the services which use the resources. Therefore, downtime which would otherwise occur with upgrades and/or modifications to resources in a network may be reduced or eliminated.

Other objects, features and advantages of the present invention will be apparent through the detailed description of the preferred embodiments and the drawings attached hereto. It is also to be understood that both the foregoing general description and the following detailed description are exemplary and explanatory and not restrictive of the scope of the invention.

### BRIEF DESCRIPTION OF THE DRAWINGS

FIG. 1 is a diagram of an architecture which may support an open programmability environment, according to an embodiment of the present invention.

FIG. 2 is a diagram of a resource management system, according to an embodiment of the present invention.

FIG. 3 is a flowchart of a method of managing changes in resource state, according to an embodiment of the present invention.

FIG. 4 is a diagram of a resource manager, according to an embodiment of the present invention.

FIG. 5 is a flowchart of a method for deployment, according to an embodiment of the present invention.

FIG. 6 is a diagram of a resource manager, according to embodiment of the present invention.

FIG. 7 is a flowchart of a method for removing deprecated resources, according to an embodiment of the present invention.

### DETAILED DESCRIPTION OF THE PREFERRED EMBODIMENTS

The present invention relates in one regard to a method and system for integrated resource management which addresses incompatibility issues related to hardware and other components in a network. The present invention enables a network (e.g., cell phone or computer network) to be programmable at a higher level without restructuring or tearing down an existing system. Thus, the system of the present invention provides improved reliability by minimizing system crashes; facilitates upgrades, additions and deletions; and provides other advantages.

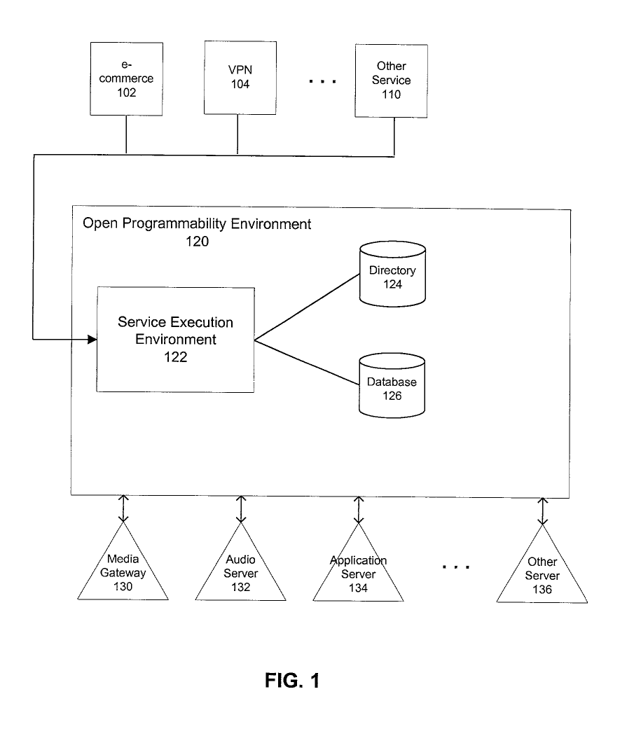

FIG. 1 illustrates an example of an architecture for supporting a system providing an open programmability environment, according to an embodiment of the present invention.

An open programmability environment 120 of the present invention provides an environment where, among other things, hardware components do not need to be hardwired to other specific types of components for communication. Instead, various data structures and control logic may be processed in order to establish proper communication with varying and multiple devices. Thus, data of differing types and variations may be received and processed without restructuring or reconfiguring the overall system.

The open programmability environment 120 of the present invention may include hardware, software, communication and other resources. As illustrated in FIG. 1, the open programmability environment 120 may support resources including a service execution environment 122, Directory 124 and Database 126. Other resources may also be included. Generally, a resource may include anything which may be needed for a service to execute successfully. For example, in a telephone network implementation, a resource may include a database, network addresses, switches, and other hardware, software, control logic or other components used to support connections. Other implementations, variations and applications may be used.

A variety of services may execute within the Service Execution Environment 122 of the Open Programmability Environment 120. These services may include, for example Virtual Private Network (“VPN”) 104, e-Commerce 102, and other service 110. These services may be accessed by a variety of means including web browsers, mobile phones, voice menus, etc.

Back-end processing may occur, for instance, through Media Gateway 130, Audio Server 132, Application Server 134, and other servers 136.

Resource management may be used to define, track, verify, resolve and manage resources both statically and dynamically. Other operations may also be performed. Static resource management may encompass the management of resources which takes place up to and including deployment to the network. An example of static resource management may involve managing whether or not a particular resource exists within a particular context. Dynamic resource management may encompass the management of resources which may take place after deployment to the network. Resource management may further involve providing a consistent management strategy across different types of resources.

According to an embodiment of the present invention, resources may be identified by a unique specifier which may involve one or more of resource ID, type ID, and version ID. Other identifiers may also be used. As resources are defined, unique specifiers may be stored on a shared server, such as Lightweight Directory Access Protocol (“LDAP”) which may involve a collection of attributes with a unique identifier, such as a distinguished name, where the directory system may be in a hierarchical structure. A LDAP directory may be used to store resource identifiers which have been used. Other resource identifiers may also be stored.

Further, a naming convention may be applied to the unique identifier. This may involve a hierarchical resource name (or identifier) which may supplement resource IDs. For example, a resource name, such as a domain name, may be a prefix to a resource ID. Such domain names may be allocated to each organization (entity or designated group) that may be capable of defining new resources. In addition, different servers may be used to store the resource IDs for each domain name.

Another embodiment of the present invention relates to resource identification. Each resource may have some type of identifier which may be used to uniquely distinguish it from other resources. For example, a method of scoping may be applied to resource identification so that a resource identifier may be considered unique within its scope. In effect, the scope of the resource becomes part of the resource's identifier. This may be accomplished through naming techniques. For example, a variety of scopes may be created to support different capabilities. Conflicts may be prevented among identifiers associated with different customers (or other entities or factors) by defining a separate scope for their resource identifiers. For example, a customer's company (or other entity or identifier) may appear as a prefix (or other supplement) to their resource identifiers. Other variations may be implemented.

Similarly, when resources are shared, shared scopes may be created. For example, a scope called “shared.beans” may be used for identifiers of software components which may be available to all service designers. Further, it may be useful to sub-divide shared software components based on predetermined criteria. Thus, the scope may be further refined by extending the scope name to accommodate various sub-categories.

Software components may involve software components that may be used in programming environments. In addition, software components may include a portable, platform-independent component model where small, reusable, software components may be created. These components may then be combined from various sources to quickly and easily create applications.

If an attempt is made to create a resource with the same resource ID, the server may indicate that the resource ID is already taken, thereby preventing conflicts. If resource IDs are changed, the old ID may be remembered as an alias of the new, primary ID. Similarly, if multiple IDs identify the same (or otherwise equivalent) resource, all but one may be considered to be aliases of the primary. As resources are up-versioned, they may be required to maintain backwards compatibility with all previous versions of the resource. If a previously existing interface or function is removed or modified, the resource may become a new entity with its own resource ID, rather than a new version of the old resource in some instances. This aspect of the invention ensures that resources may be up-versioned transparently to entities that use them.

Once resources are deployed, entities may retrieve references to them by using a unique specifier, which may include one or more of a resource ID, version ID and type ID. A resource manager may use the unique specifier to find the requested resource and return a reference to the requested resource. This resource may be a resource with a newer version ID than that which was requested.

It may also be desired to interface with external systems which may use different approaches for resource identification. For example, there may be a need for the resource management infrastructure to keep track of objects which are stored in an external or other system. Thus, rules may be used to map between identifiers used by an external system and those used internally for resource identifiers to enable the use of a single consistent resource management infrastructure.

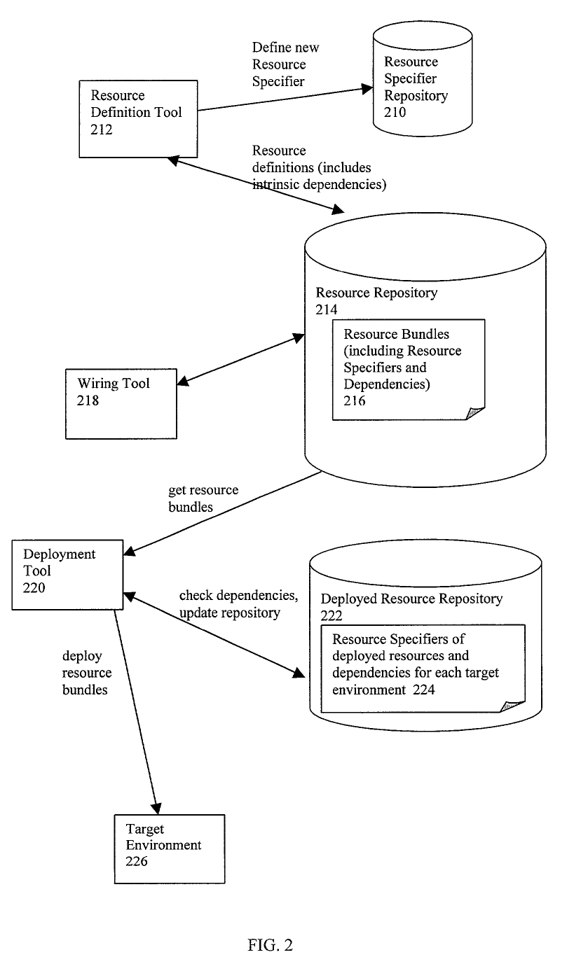

FIG. 2 illustrates an example of a resource management system, according to an embodiment of the present invention. The resource manager of the present invention may serve to tie together various aspects of static resource management and dynamic resource management. For example, static resource management may involve allocation, deployment, etc. while dynamic resource management may involve event/state correlation. When a new resource is defined, the resource's relationship to other resources may be defined in terms of predefined rules, definitions or other criteria. Thus, varying relationships among and between resources may be established, thereby creating a network of resource dependency definitions and/or rules.

As illustrated in FIG. 2, static resources, for example, may be managed by the resource management system of the present invention.

There may be a variety of Resource Definition Tools, according to an embodiment of the present invention. For example, each different type of resource may be associated with a separate definition tool. Resource Definition Tool 212 may define a new resource specifier, and store it in the Resource Specifier Respository 210, verifying that it is unique. There may be a number of resource repositories where the repositories do not need to be physically co-located.

Resource Definition Tool 212 may communicate resource definitions to Resource Repository 214 where resource definitions may include intrinsic dependencies and other relevant information. For example, resource definitions may include dependencies which are intrinsic to the resource. If a service is defined, and that service uses a particular software component (e.g., JavaBean), the definition of the service may explicitly include a dependency on the identified software component. In addition, resource definitions may also include the Resource Specifiers of the defined resources. Other relevant information may also be included.

According to an embodiment of the present invention, Resource Repository 214 may be centralized so that universal uniqueness of newly defined Resource Specifiers may be guaranteed. The centralization may be realized by delegating management of portions of the Resource Specifier name space to physically separate repositories.

Wiring Tool 218 may be given access to any repository which contains the resources it is accessing. Wiring Tool 218 may read in Resource Bundles 216, which may be stored in Resource Repository 214 and allow relationships to be defined between the resources in the bundles. These wired relationships may constitute extrinsic dependencies between resources. It may generate as output another resource bundle, which may contain these dependencies between the resources which are part of the bundle.

For example, a FreePhone service (800) may generate an event dictating that a phone call should be routed to a particular number, a Local Number Portability (“LNP”) service may accept such an event and translate it to route to a different number. Neither of these services is intrinsically dependent on the other, but by “wiring” these two services together into a bundle (such that they may interwork when the bundle is deployed) and extrinsic dependency is defined between them. This process may be iterative thereby creating larger and larger nested bundles of resources.

Information related to resource bundles from Resource Bundles 216 may be retrieved by Deployment Tool 220. Deployment Tool 220 may deploy one or more resource bundles to a target environment 226 or other destination. At deployment, Deployment Tool 220 may check Deployed Resource Repository 222 for dependencies and update the repository. Repository 222 may track and maintain the Resource Specifiers of resources which have been deployed to each target environment or other destination, the dependencies between all these resources and other relevant information, as shown by 224.

When a resource bundle is deployed, its dependencies may be checked against Deployed Resource Repository 222. If deployment proceeds, then the resource specifiers in the newly deployed bundle and the dependencies of the newly deployed bundle may be added to Deployed Resource Repository 222 for the specific target environment.

Deployment Tool 220 may also allow resources to be removed from a target environment. In this case, the Deployed Resource Repository 222 may be checked to ensure that the dependencies of all remaining resources are still satisfied.

In essence, a resource manager may provide a set of basic resource management services which may be used to build higher level resource management functionality which may include the ability to designate a globally unique identifier for a resource, use a resource identifier to determine whether a resource is present, use a resource identifier to retrieve a resource, store a resource along with its identifier for later retrieval, record the dependencies of a resource along with the information on the nature of the dependency, verify that the dependencies of a resource are satisfied, and perform other operations.

According to another example of the present invention, a resource type ID may be used to retrieve a resource resolution mechanism. If the resource ID is an alias, it may be mapped to the primary ID of the resource. The resource resolution mechanism may be given the primary resource ID and version ID and may use any approach necessary to retrieve the requested resource. For example, typical local software resource may be retrieved by using a hash map to map the resource ID to the resource itself. Proxies for remote resources may be retrieved using Jini server connections. Connections to remote nodes may be retrieved by mapping the resource ID to the IP address and port to be accessed, opening a TCP/IP connection to it, and returning the protocol handler as a proxy for the remote node. The resource resolution mechanism may return the requested resource, with a version greater than or equal to the requested version ID when appropriate.

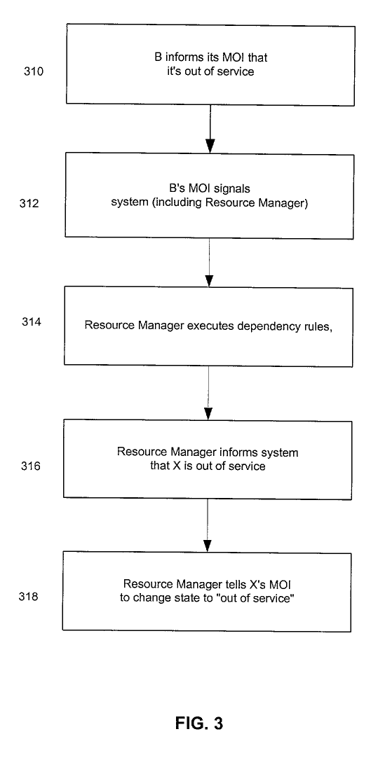

In an example of dynamic resource management according to the present invention, if a resource X needs B and B goes out of service, the present invention provides an efficient method for managing changes in resource state, as shown by FIG. 3. At step 310, B may inform its Managed Object Interpreter (“MOI”) that it is out of service, or otherwise disabled or hindered. Other information may also be conveyed. At step 312, B's MOI may signal the change in status to a system, which may include the resource manager. The change in status may also be forwarded to other destinations. At step 314, the resource manager may execute the appropriate dependency rules where it will discover that X needs B. At step 316, the resource manager may inform the system that X is now out of service, or otherwise disabled or hindered. At step 318, the resource manager (or system) may communicate to X's MOI to change its state to “out of service” or other state.

According to another example, the resource manager of the present invention may be applied to services, which generally have a simplistic, per-query view of resources.

The present invention removes the burden of relationship management from the resources themselves. Each resource may maintain an interface to its MOI to properly manage and understand its state. In other words, resources do not have to include quasi-management code to explicitly state that if a resource that a resource depends upon is unavailable, then the resource is unavailable as well. Similarly, the resource manager of the present invention does not preclude smart resources from providing quasi-management code, but the resource manager does allow simple resources to be naïve when it is advantageous for development effort, code management and other reasons.

Thus, resource relationships may be altered and managed through the resource manager without having to directly involve the resource.

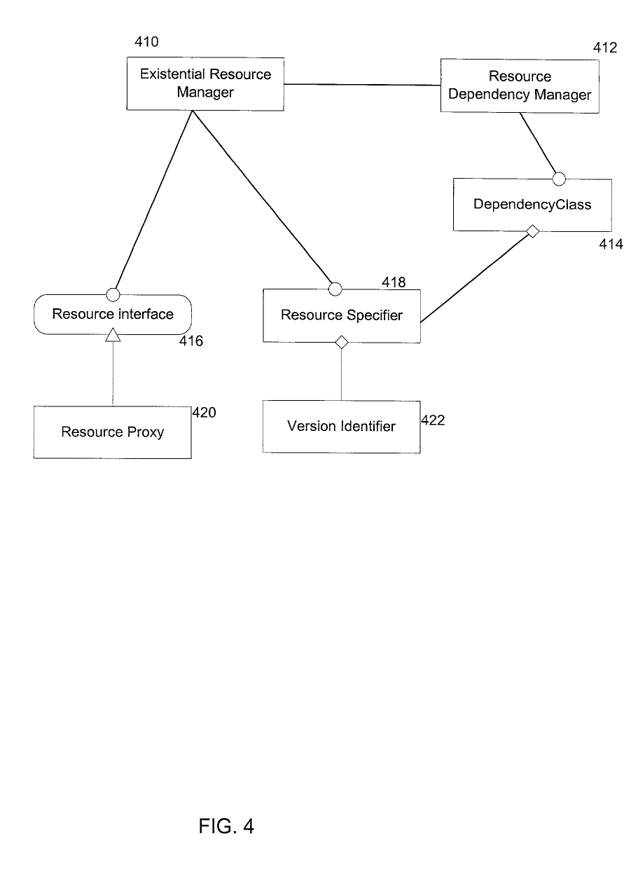

According to an embodiment of the present invention, a resource manager may include various components as illustrated in FIG. 4. Resource manager may comprise Existential Resource Manager 410, Resource Dependency Manager 412, Dependency Class 414, Resource Interface 416, Resource Proxy 420, Resource Specifier 418, and Version Identifier 422. Other components may also be implemented.

Existential Resource Manager (“ERM”) 410 may provide functionality related to keeping track of what resources exist within a given environment or other parameters. Since different resources may exist in different environments, each environment in which resources may exist may have its own instance of the ERM.

Resource Dependency Manager (“RDM”) 412 may be responsible for keeping track of the dependencies between or among resources. Any functionality related to the storing or checking of these dependencies may be provided by RDM 412. Thus, resource relationships may be altered and managed through the resource manager without having to directly involve the resource.

Resource Specifier 418 may uniquely identify a resource, its version, and other resource characteristics. When an entity wants to identify a dependency on a resource or request a resource, it may do so by using a resource specifier. For example, when the resource manager is requested to check dependencies or retrieve a resource, it may ensure that the resources found are compatible with those required. Thus, a returned resource may be a newer version than the one requested, and its true resource identifier may be an alias of the one requested.

When resource specifiers are aliases for the true specifier of a resource, they may have references to the primary resource specifier. In addition, the resource manager may store references to the resources themselves or to their proxies/managers within the resource specifier.

The Version Identifier 422 may allow the comparison of versions of the same resource. It may be implemented as a class so that different version numbering schemes may be implemented as subclasses if required.

A Resource Interface 416 may be a utility interface which may be implemented by one or more resource classes.

A Resource Proxy 420 may be a class that provides a concrete implementation of the resource identifier. In addition, it may provide a means of retrieving an associated resource. This may be used by RDM 412 to represent resources. To optimize runtime resource allocation, subclasses of Resource Proxy 420 may be implemented which keep references to either resource object directly, or to resource pool managers which control the allocation of particular types of resources.

Dependency Class 414 may be used to represent a dependency between two or more resources. Other information may also be provided. Generally, a resource may be dependent on another resource or other entity. For example, there may be different types of dependencies an entity may have on a resource. For example, an entity may contain a resource. Also, an entity may use a resource without containing it. Generally, an entity may not exist without a resource which it contains. If an entity uses (but does not contain) a resource, it may passively exist without the resource, but may not operate (or execute) without the resource.

One aspect of static resource management may involve keeping track of the resources which exist, their versions and other characteristics. The present invention provides a data management interface that may store identifiers and versions of each entity which exists in a given context, as well as other information. A consistent resource identification and versioning strategy may be applied across resource types.

If an entity uses a specific resource, then it is generally considered to be dependent upon that resource. The action of specifying that the entity uses the resource may define the dependency. For example, when a service designer places a bean into a service, that act may implicitly establish the fact that the service depends on the bean. In addition, other resource dependencies may be completely implicit. Also, resource dependencies may require explicit designation by a service designer or other entity.

Most resources which may be deployed to a network have dependencies on either hardware or software which may be specific to a certain node type in the network. The present invention presents a method of defining a resource which represents the required capability and defining the dependency on that resource. Thus, this approach has the benefit of identifying and recording true dependencies on functionality rather than artificially defining sets of functionality as belonging to different nodes. This makes deployment independent of an arbitrary “node type” concept and enables the splitting and combining of nodal functions in the network, without modification to either the deployment tool, or the deployed resources.

For example, if a service requires a communication channel to a remote node, and that communication channel goes down, then the service is also down. Since the communication channel does not know what is dependent upon it, there is no way for the communication channel to give explicit notification to its dependents. Thus, the service will not know the communication channel is down until the service tries to use it. The present invention provides a method and system for communicating explicit indication of the consequences of any given outage of performance degradation. This may be achieved by propagating state change information. In addition, it may be useful to retrieve direct indication of the root cause of any service problems. Thus, the present invention provides a method and system for connecting (or associating) the MOIs of different entities together via the dependency relationships stored in the resource management infrastructure of the present invention.

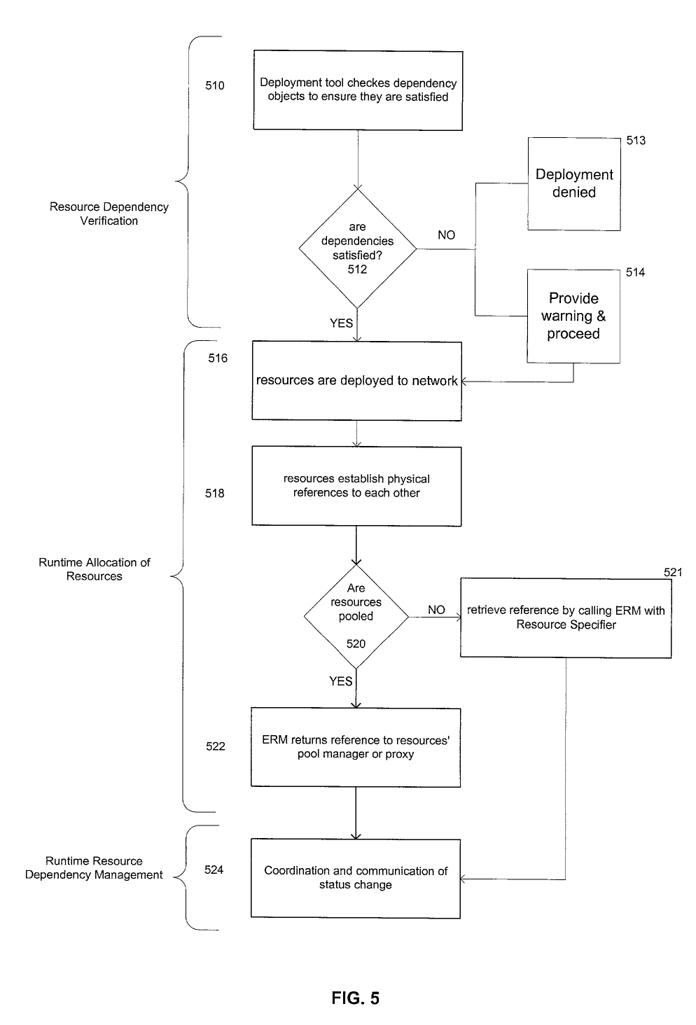

FIG. 5 illustrates an example of steps related to a deployment tool, according to an embodiment of the present invention. First, resource dependencies may be verified. Next, resources may be allocated at runtime. Then, resource dependencies may be managed.

At step 510, a deployment tool may check dependency objects in the deployed package to ensure that they are satisfied by the package itself or by resources which have previously been deployed to the network. At step 512, it may be determined whether one or more dependencies are satisfied. If one or more dependencies are not satisfied, the deployment tool may deny the deployment, at step 513. In addition, the tool may provide a warning and proceed with deployment, at step 514, depending on the nature of the dependency and other factors. Other options may be available if one or more dependencies are not satisfied.

After dependencies have been examined, allocation of resources may occur at runtime and deployment may proceed. At step 516, a set of resources may be deployed to the network. At step 518, these resources may establish physical references to each other in order to communicate and perform other functions.

At step 520, it may be determined whether resources are pooled or not (using, for example, the resource typeID). Simple resources which are not pooled may be retrieved by calling an existential resource manager with a resource specifier where a reference to the resource object requested may be delivered, at step 521.

According to another example, resource pools may be managed in dynamic resource management. When a set of homogenous entities are used interchangeably on a dynamic basis, they may be placed into a pool and allocated to dependent objects as needed. In such a case, a permanent dependency relationship between the pooled entity and its one or more dependent objects is not defined. Rather, a relationship between the dependent object and the pool manager may be created. The pool manager may behave as a proxy for the pooled entities, handling the dependency relationships.

When the resources are pooled, the existential resource manager may return a reference to the resource's pool manager, or a proxy for the resource itself thereby enabling the manager or proxy to retrieve the actual resource, at step 522. Thus, distinctions between simple and pooled resources from the requesting entity may be hidden so that different types of requests may occur through a runtime resource manager interface.

Once resources are successfully deployed to the network and appropriate references between them have been established, coordination and communication of status changes between/among resources may be established, at step 524.

A resource may be requested from the ERM using a resource specifier (resourceID, typeID, and/or versionID). When the ERM receives the resource specifier, it may apply a variety of algorithms to actually retrieve the resource. The ERM may apply a different algorithm based on the typeID of the requested resource. For example, some types of resources may be retrieved from an internal hashtable. Other types of resources may be retrieved from the local file system, a database, an LDAP server, an HTTP server, etc. Some types of resources may have more elaborate retrieval mechanisms. For example, the ERM may attempt to retrieve a resource from an internal hashtable, and if it is not found, may attempt to find the resource using some other approach. Other variations may be implemented.

Furthermore, the resource retrieval mechanisms in the ERM may be arbitrarily extensible and configurable. It may use different retrieval mechanisms in different deployment scenarios, and different retrieval mechanisms may be added over time.

Some resource types may be managed by pool managers, which may in turn be accessed via the resource retrieval mechanism used by the ERM. When a homogeneous set of resources are pooled, the existential resource manager may use the resources' pool manager, as the resource access strategy 640 for that type of resource. Thus, distinctions between simple and pooled resources from the requesting entity may be hidden so that different types of requests may occur through a runtime resource manager interface.

Some types of resources may have their resource retrieval mechanism further distinguished by other means. For example, the scope portion of a resourceID may be used to select a different resource retrieval mechanism for different scopes. The retrieval mechanism which is actually used may be transparent to the requesting entity.

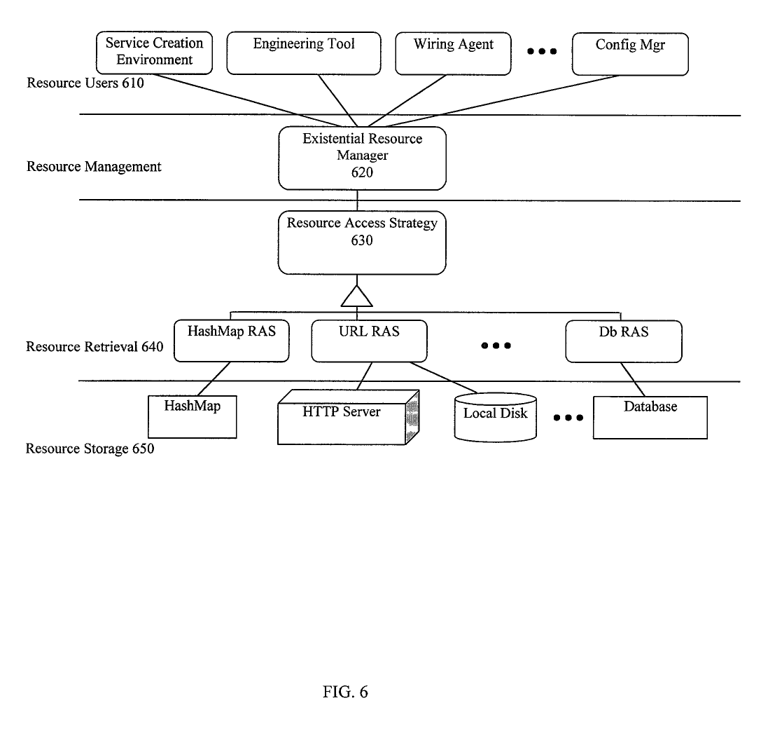

FIG. 6 illustrates how the ERM provides resources which may be retrieved from many different access mechanisms, according to an embodiment of the present invention. Further, resources may be retrieved transparently to the requesting entity. According to an embodiment of the present invention, the ERM may hide different resource retrieval mechanisms from the requester.

Resources may be accessed through the ERM by various methods, such as accessing an internal hashmap. Alternative resource access strategies may be also implemented, such as access via a URL, access from a file system, retrieval of a proxy for a remote resource and other methods of accessing resources.

Each access strategy may incorporate a way of locating a resource based on its resource specifier (or other identifier), which may include resource ID, typeID, and/or version ID. Types of resource access which may be supported may include retrieval, querying the existence of the resource, creation of a new resource and up-versioning of a resource.

FIG. 6 illustrates an example of resource retrieval architecture incorporating various access strategies, according to an embodiment of the present invention.

Resource Users 610 may include a Service Creation Environment, Engineering Tools, Wiring Agents, Configuration Manager and other entities implementing and utilizing resources.

Existential Resource Manager 620 may manage the resources, according to an embodiment of the present invention. Resource Access Strategy (“RAS”) 630 may be implemented to retrieve resources. Resource Retrieval 640 may be accomplished though HashMap RAS, URL RAS, Database RAS and other methods of resource access.

Resource storage 650 may occur at HashMap, HTTP Server, a Local Disk, Database, and other methods of storing resources and other objects.

Further, strategies which are implemented may be configurable to enable resource specific strategies.

The ERM of the present invention may be extended to allow alternative resource access strategies on a per-resource name space branch basis. For example, an alternative resource access strategy may be applied to a specific resource or group of common or related resources. This enables a resource access strategy to be easily applied to a whole broad category of resources easily, while still enabling different strategies to be applied on varying degrees of specificity, such as a single resource.

For some applications, it may be useful to assign a particular resource access strategy across an entire resource type (e.g., all resources which share the same typeID in their Resource Specifier).

According to another embodiment of the present invention, when the attempted retrieval of a resource fails, a second default access strategy may be used. For example, this may be applied when the access strategy which was used can not find the resource, so as far as it is concerned the resource does not exist.

In another manifestation of the ERM, a resource user may ask the ERM for the resource, and when it is not found in a resource storage, the ERM may access an alternative resource access strategy to retrieve the resource. This allows the ERM's local hashmap to effectively behave as a resource cache.

A resource manager may provide information to appropriate entities that may be considered necessary to understand relationships and other factors between/among different types of resources. For example, dependency objects may contain information which may define how state changes in one resource may affect the state of dependent entities. State changes may then be forwarded to dependent entities so that the state of those dependent entities may be appropriately changed.

As software evolves, it is natural that functionality may be added and/or modified. Generally, it is undesirable and inefficient to treat each new version of a resource as a unique entity, since this approach may result in multiple versions of the same entity co-existing for no significant reason. This approach may lead to inefficiencies and wasted space. It also makes upgrading a given resource difficult, since all of its dependencies must be updated to use the new resource at the same time as the resource itself is upgraded. According to an embodiment of the present invention, a resource may have an associated version ID.

In order to smoothly handle upgrades of resources, a new version of a resource may fully support functionality and interfaces provided by the version which it succeeds, implicitly encompassing all previous versions. Thus, multiple versions of the same resource in parallel do not need to be maintained. For example, if a new resource does not support functionality and interfaces provided by an older resource, then the resources are not two different versions of the same resource. Instead, they are two distinct resources, each with its own unique resource identifier. The present invention facilitates the removal of old functionality where deprecated resources may be gradually removed from the system.

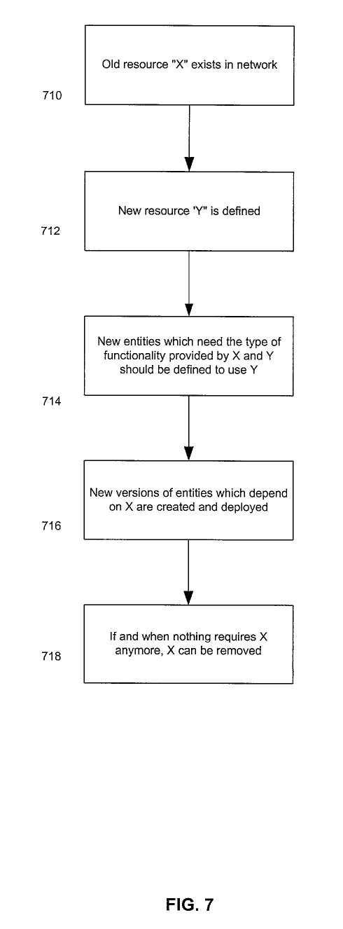

FIG. 7 illustrates a flowchart of a method for removing deprecated resources, according to an embodiment of the present invention. At step 710, an old resource “X” may currently exist in the network. At step 712, a new resource “Y” may be defined which will eventually replace “X”, In this example, the new resource “Y” may support some of the same functionality as “X”, but does not support some of “X”'s interfaces. Thus, “Y” may not be a new version of X, but rather a unique resource. At step 714, new entities which may need the type of functionality provided by “X” and “Y” may be defined to use “Y”. At step 716, as new versions of entities which depended on “X” may be created and deployed, they may be redefined to use “Y” instead. Old entities which need “X” may continue to use “X”. Thus, “X” and “Y” may co-exist in the system for as long as necessary. At step 718, if and when nothing in a given context requires “X” anymore, “X” may be removed. Eventually, “X” may be completely removed from the system.

Other embodiments and uses of the invention will be apparent to those skilled in the art from consideration of the specification and practice of the invention disclosed herein. The specification and examples should be considered exemplary only.

What is claimed is:

1. A method for providing integrated resource management comprising the steps of:
a) identifying a resource for deployment to a network wherein a unique specifier is assigned to the resource;
b) storing resource identification information in a centralized repository, wherein resource identification information is associated with the unique specifier; and
c) enabling resource retrieval based on the unique specifier.

2. The method of claim 1 further comprising the step of ensuring dependencies related to the resource are satisfied.

3. The method of claim 1 wherein the unique specifier comprises one or more of a resource identifier, a type identifier, and a version identifier.

4. The method of claim 1 wherein the unique specifier comprises a resource identifier, a type identifier, and a version identifier.

5. The method of claim 1 wherein the unique specifier comprises a hierarchical resource name that is allocated to an entity.

6. The method of claim 5 wherein the hierarchical resource name comprises a domain name.

7. The method of claim 6 wherein the domain name is a part of the unique specifier.

8. The method of claim 1 wherein resource management comprises static resource management and dynamic resource management.

9. The method of claim 8 wherein static resource management comprises allocation and deployment.

10. The method of claim 8 wherein dynamic resource management comprises event state correlation.

11. The method of claim 2 wherein the step comprising ensuring dependencies are satisfied further comprises the step of utilizing a deployment tool.

12. The method of claim 11 wherein the deployment tool deploys the resource to the network and deploys information related to one or more of the resource's relationships, definition and identity to a resource manager.

13. The method of claim 11 wherein the deployment tool deploys the resource to the network and deploys information related to one or more of the resource's relationships, definition and identity to a repository accessible to a resource manager.

14. The method of claim 12 wherein the information related to the resource's relationships comprises dependency information wherein dependency information comprises a definition of the nature of a dependency and an identifier of a dependent entity.

15. The method of claim 12 wherein the resource manager denies deployment of the resource if dependencies are not satisfied.

16. The method of claim 12 wherein the resource manager provides a warning wherein the warning provides information related to unsatisfied dependencies and proceeds with deployment of the resource if dependencies are not satisfied.

17. The method of claim 1 wherein resource retrieval comprises utilizing a hash map for local software resources.

18. The method of claim 1 wherein resource retrieval comprises receiving proxies for remote resources.

19. The method of claim 1 wherein the step of enabling resource retrieval further comprises requesting a resource from a resource manager using a resource specifier.

20. The method of 19 wherein the resource manager applies a different algorithm to retrieve the resource based on a type identifier of the requested resource.

21. The method of claim 19 wherein the resource manager applies one or more strategies based on the resource specifier.

22. The method of claim 21 wherein the one or more strategies are based on a hierarchical system.

23. The method of claim 1 wherein the step of enabling resource retrieval further comprises utilizing one or more resource retrieval mechanisms that are extensible to allow one or more alternative resource access strategies.

24. The method of claim 1 wherein the step of enabling resource retrieval further comprises utilizing one or more resource retrieval mechanisms that are configurable to enable one or more resource specific strategies.

25. The method of claim 1 wherein the step of enabling resource retrieval further comprises utilizing one or more resource retrieval mechanisms that are transparent to a requesting entity.

26. The method of claim 1 wherein the step of enabling resource retrieval further comprises assigning a particular resource access strategy to an entire resource type.

27. The method of claim 1 wherein the step of enabling resource retrieval further comprises implementing a default access strategy.

28. The method of claim 1 further comprising a step of referencing a primary resource specifier from one or more alias resource specifiers so that when a resource specifier is modified, one or more resource users which access the resource specifier will retrieve a modified version.

29. The method of claim 1 further comprising a version strategy.

30. The method of claim 29 wherein the version strategy comprises the step of requesting a resource with a particular version ID to retrieve the particular version or a newer version of the resource.

31. The method of claim 30 wherein the newer version is upward compatible with one or more previous versions of the resource.

32. A system for providing integrated resource management comprising:
a) identification means for identifying a resource for deployment to a network wherein a unique specifier is assigned to the resource;
b) storing means for storing resource identification information in a centralized repository, wherein resource identification information is associated with the unique specifier; and
c) retrieval means for enabling resource retrieval based on the unique specifier.

33. The system of claim 32 further comprises ensuring means for ensuring dependencies related to the resource are satisfied.

34. The system of claim 32 wherein the unique specifier comprises one or more of a resource identifier, a type identifier, and a version identifier.

35. The system of claim 32 wherein the unique specifier comprises a resource identifier, a type identifier, and a version identifier.

36. The system of claim 32 wherein the unique specifier comprises a hierarchical resource name that is allocated to an entity.

37. The system of claim 36 wherein the hierarchical resource name comprises a domain name.

38. The system of claim 37 wherein the domain name is a part of the unique specifier.

39. The system of claim 32 wherein resource management comprises static resource management and dynamic resource management.

40. The system of claim 39 wherein static resource management comprises allocation and deployment.

41. The system of claim 39 wherein dynamic resource management comprises event state correlation.

42. The system of claim 33 wherein ensuring dependencies are satisfied are accomplished through a deployment tool.

43. The system of claim 42 wherein the deployment tool deploys the resource to the network and deploys information related to one or more of the resource's relationships, definition and identity to a resource manager.

44. The system of claim 42 wherein the deployment tool deploys the resource to the network and deploys information related to one or more of the resource's relationships, definition and identity to a repository accessible to a resource manager.

45. The system of claim 44 wherein the information related to the resource's relationships comprises dependency information wherein dependency information comprises a definition of the nature of a dependency and an identifier of a dependent entity.

46. The system of claim 44 wherein the resource manager denies deployment of the resource if dependencies are not satisfied.

47. The system of claim 44 wherein the resource manager provides a warning wherein the warning provides information related to unsatisfied dependencies and proceeds with deployment of the resource if dependencies are not satisfied.

48. The system of claim 32 wherein retrieval means further comprises utilizing a hash map for local software resources.

49. The system of claim 32 wherein retrieval means further comprises receiving proxies for remote resources.

50. The system of claim 32 wherein retrieval means further comprises requesting means for requesting a resource from a resource manager using a resource specifier.

51. The system of 50 wherein the resource manager applies a different algorithm to retrieve the resource based on a type identifier of the requested resource.

52. The system of claim 50 wherein the resource manager applies one or more strategies based on the resource specifier.

53. The system of claim 52 wherein the one or more strategies are based on a hierarchical system.

54. The system of claim 32 wherein retrieval means further comprises utilization means for utilizing one or more resource retrieval mechanisms that are extensible to allow one or more alternative resource access strategies.

55. The system of claim 32 wherein the retrieval means further comprises utilization means for utilizing one or more resource retrieval mechanisms that are configurable to enable one or more resource specific strategies.

56. The system of claim 32 wherein the retrieval means further comprises utilization means for utilizing one or more resource retrieval mechanisms that are transparent to a requesting entity.

57. The system of claim 32 wherein the retrieval means further comprises assigning means for assigning a particular resource access strategy to an entire resource type.

58. The system of claim 32 wherein the retrieval means further comprises implementation means for implementing a default access strategy.

59. The system of claim 32 further comprising a referencing means for referencing a primary resource specifier from one or more alias resource specifiers so that when a resource specifier is modified, one or more resource users which access the resource specifier will retrieve a modified version.

60. The system of claim 32 further comprising a version strategy.

61. The system of claim 60 wherein the version strategy comprises requesting means for requesting a resource with a particular version ID to retrieve the particular version or a newer version of the resource.

62. The system of claim 61 wherein the newer version is upward compatible with one or more previous versions of the resource.
